(19) United States
(12) Patent Application Publication
(10) Pub. No.: US 2015/0025705 A1
(43) Pub. Date: Jan. 22, 2015

(54) DRIVER PROFILE CONTROL SYSTEM FOR MOTOR VEHICLES

(71) Applicant: GM Global Technology Operations LLC, Detroit, MI (US)

(72) Inventor: Kevin S. Burger, Sterling Heights, MI (US)

(21) Appl. No.: 13/943,420

(22) Filed: Jul. 16, 2013

(51) Int. Cl. B60R 16/037

(52) U.S. Cl. CPC B60R 16/037
USPC 701/1

(57) ABSTRACT

A driver profile control system includes a driver identification module configured to receive a driver specific identifier, and a driver profile manager module operatively connected to the driver identification module. The driver profile manager module includes one or more driver profiles. One of the one or more driver profiles is associated with the driver specific identifier. A driver profile control module is operatively connected to the driver profile manager module. The driver profile control module is configured and disposed to establish the one of the one or more driver profiles associated with the driver specific identifier.

### FIELD OF THE INVENTION

The subject invention relates to the art of motor vehicles and, more particularly, to a driver profile control system for a motor vehicle.

### BACKGROUND

Motor vehicles include radios that include various presets that allow a driver to program desired stations. Certain vehicles include a seat memory function that allows a car owner to program a desired seat position for one or more drivers. With the push of a button, a driver's seat is automatically adjusted to a driver's preferred setting. Motor vehicles are now being offered with a greater number of options including a global positioning systems (GPS) unit, satellite radio, internet access and the like. Motor vehicles also include multiple control modules that enable more versatile control of various systems including engine systems, passenger compartment systems and the like. In some instances, control over the various systems is established by a computer chip embedded in a key associated with the motor vehicle.

The key does not identify a specific driver but rather systems associated with the holder of the key. Multiple drivers may have access to the key including new or inexperienced drivers, and valet parking attendants. In such cases, the key does not control driver specific preferences and may allow access to vehicle systems a car owner would prefer to be inaccessible. Accordingly, it is desirable to provide a car owner with a control system that provides a driver with greater flexibility in programming and setting specific driver and/or owner specific preferences for various ones of the motor vehicle systems.

### SUMMARY OF THE INVENTION

In accordance with an exemplary embodiment, a driver profile control system includes a driver identification (ID) module configured to receive a driver specific identifier, and a driver profile manager module operatively connected to the driver identification (ID) module. The driver profile manager module includes one or more driver profiles. One of the one or more driver profiles is associated with the driver specific identifier. A driver profile control module is operatively connected to the driver profile manager module. The driver profile control module is configured and disposed to establish the one of the one or more driver profiles associated with the driver specific identifier.

In accordance with another exemplary embodiment, a motor vehicle includes a vehicle body supporting an engine, an environmental control system, an external communication system, a comfort control system, and a driver profile control system configured and disposed to enable a driver to establish a driver specific profile, including driver preference settings for one or more of the engine, the environment control system, the external communication system and the comfort control system. The driver profile control system includes a driver identification (ID) module configured to receive a driver specific identifier, and a driver profile manager module operatively connected to the driver identification (ID) module. The driver profile manager module includes one or more driver profiles. One of the one or more driver profiles is associated with the driver specific identifier. A driver profile control module is operatively connected to the driver profile manager module. The driver profile control module is configured and disposed to establish the one of the one or more driver profiles associated with the driver specific identifier.

In accordance with yet another exemplary embodiment, a method of establishing a driver specific profile for a motor vehicle includes receiving a driver specific identifier through an input device, associating the driver specific identifier with a driver profile, and establishing driver specific vehicle setting preferences stored in the driver profile.

The above features and advantages, and other features and advantages of the invention, are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a plan view of a motor vehicle including a driver profile control system in accordance with an exemplary embodiment;

FIG. 2 is a dataflow diagram of the driver profile control system of FIG. 1;

and

FIG. 3 is a flow chart illustrating a method of establishing a driver specific profile for a motor vehicle in accordance with an exemplary embodiment.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features. As used herein, the term “module” refers to an application specific integrated circuit (ASIC), an electronic circuit, a processor (shared, dedicated, or group), memory that executes one or more software or firmware programs, a combinational logic circuit, and/or other suitable components that provide the described functionality. When implemented in software, a module can be embodied in memory as a non-transitory machine-readable storage medium readable by a processing circuit and storing instructions for execution by the processing circuit for performing a method.

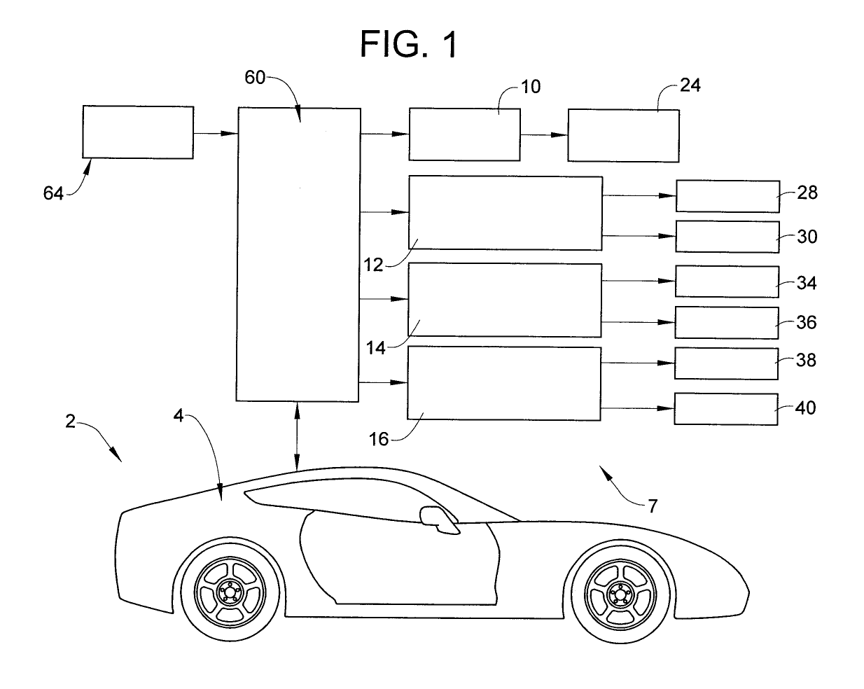

A motor vehicle, in accordance with an exemplary embodiment, is indicated generally at 2 in FIG. 1. Motor vehicle 2 includes a body 4 that houses motor vehicle systems 7. Motor vehicle systems 7 include, but are not limited to, an engine 10, an environmental control system 12, an external communication system 14, and a comfort control system 16. Engine 10 includes a speed and power control 24 that may limit a top speed or power output of engine 10. Environment control system 12 includes a heater 28 and an air conditioner 30 that establish a desired passenger compartment temperature for motor vehicle 2. External communication system 14 may include an Internet access point 34 and a global positioning system (GPS) device 36. Internet access point 34 enables a driver and/or a passenger to access the Internet, send text messages and the like. GPS device 36 includes maps and route information. Comfort control system 16 may include a seat positioning control 38 that establishes preferred drivers seat position preferences. Comfort control system 16 may also include an audio system 40. Audio system 40 may include standard AM/FM radio and a compact disc (CD) player, MP3 player, and/or a satellite radio with access to both free and subscription services.

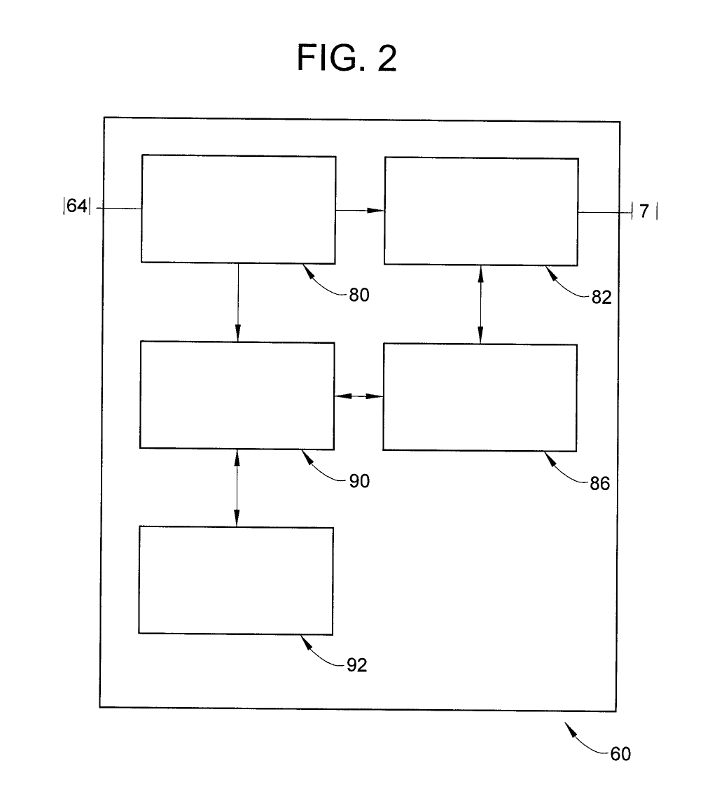

In accordance with an exemplary embodiment, motor vehicle 2 includes a driver profile control system 60 that establishes driver specific preferences for one or more of motor vehicle systems 7. Driver profile control system 60 is operatively connected to motor vehicle systems 7 and an input device 64. As will be detailed more fully below, input device 64 may be a keyboard, touchscreen, or a biometric reader that receives a driver specific identifier associated with a particular driver or user of motor vehicle 2. As shown in FIG. 2, and with continued reference to FIG. 1, driver profile control system 60 includes a driver identification (ID) module 80 operatively connected to input device 64 and a driver profile control module 82. Driver Profile Control module 82 loads a driver specific profile stored in a driver profile manager module 86 associated with the driver identification module 80. The driver specific profile includes preferred settings for one or more of motor vehicle systems 7. If the driver identifier is not associated with a driver profile, driver profile control module 82 enables a valet mode that provides limited access to motor vehicle systems 7.

Driver profile control system 60 also includes a driver profile programming module 90 that enables a driver to build a driver specific profile and establish desired parameters for motor vehicle systems 7. Driver profile programming module 90 initially sets a driver identifier associated with a profile. The driver identifier may be an alpha-numeric code or biometric data entered through input device 64. Driver profile programming module 90 may be accessed through a specific code provided to an owner of motor vehicle 2, or by a driver having an existing driver identifier. In such a case, a new driver identifier need not be established. After establishing the driver identifier or accessing a profile associated with an existing driver identifier, profile changes may be performed. The driver may select desired temperature ranges for environmental control system 12, seat settings and audio settings for comfort control system 16, vehicle speed and performance settings, or other user programmable options from a list stored in an available program options module 92.

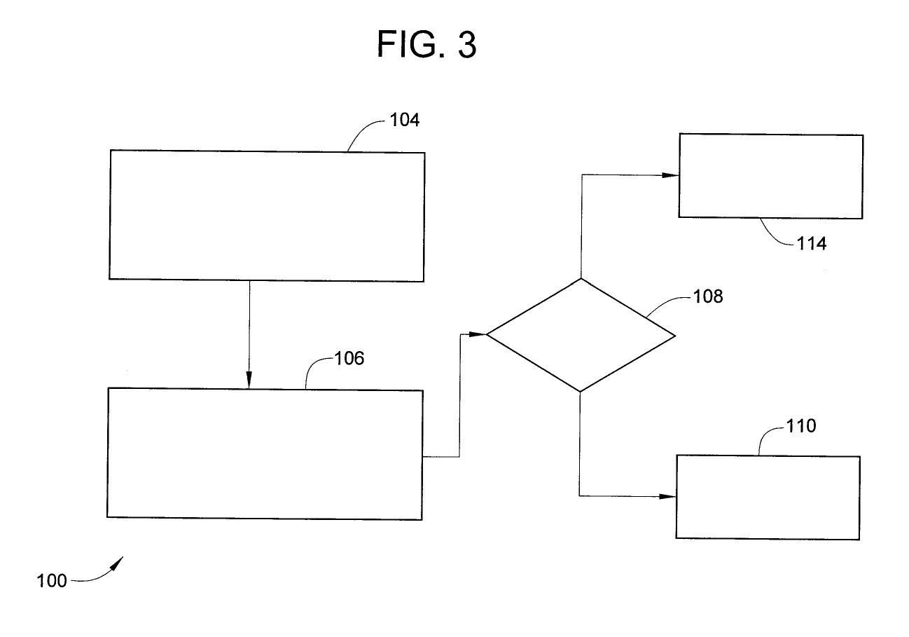

In accordance with an aspect of the exemplary embodiment, a driver/owner may set up a driver identifier for himself, for another, experienced, driver and/or for a new driver. In the case of a new driver, the driver identifier may be associated with a driver specific profile having limits on what systems are accessible. Reference will now follow to FIG. 3, and with continued reference to FIGS. 1 and 2, in describing a method 100 of establishing a driver specific profile for motor vehicle 2. Initially, a driver inserts an ignition key into an ignition switch and may start the car, as shown in block 104. At this point, the driver is prompted for a driver specific identifier in block 106. The driver specific identifier may be a password, a numeric code, an alpha-numeric code or a biometric identifier such as a fingerprint, voice print or other biometric identifier. In block 108, driver identification (ID) module 80 identifies the driver specific identifier. For example, driver identification (ID) module 80 may compare the entered driver specific identifier with values stored in driver profile control module 82. If the driver specific identifier is recognized, the associated driver specific profile is retrieved from driver profile manager module 86 and implemented by driver profile control module 82 in block 110. If, on the other hand, the driver specific identifier is not recognized, driver profile control module 82 activates a valet mode in block 114. In valet mode, the driver has access to only those basic controls necessary to park motor vehicle 2. Access to other systems, such as glove box access, infotainment (radio) functionality, trunk spaces and the like may be restricted. Additionally, GPS monitoring may be enabled and vehicle performance restricted.

At this point it should be understood that the exemplary embodiments describe a system that enables a driver to establish driver specific presets for a motor vehicle. The driver specific presets are only available to a driver having a driver specific identifier that is associated with those presets. In this manner, not only may a driver tailor various motor vehicle systems to his/her particular preferences, but also an owner may place limits on systems accessible to less experienced drivers. It should also be understood that the specifics of the driver profile control system are exemplary. The actual components of the driver profile control system may vary.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. A driver profile control system comprising:
a driver identification module configured to receive a driver specific identifier;
a driver profile manager module operatively connected to the driver identification module, the driver profile manager module including one or more driver profiles, one of the one or more driver profiles being associated with the driver specific identifier; and
a driver profile control module operatively connected to the driver profile manager module, the driver profile control module being configured and disposed to establish the one of the one or more driver profiles associated with the driver specific identifier.

2. The driver profile control system according to claim 1, further comprising:
a driver profile programming module operatively connected to the driver profile manager module, the driver profile programming module being configured and disposed to establish the one or more driver profiles.

3. The driver profile control system according to claim 2, further comprising:
an available programmable options module including a database listing available programming options for the one or more driver profiles.

4. The driver profile control system according to claim 1, further comprising:
an input device operatively connected to the driver identification module, the input device being configured and disposed to receive the driver specific identifier.

5. The driver profile control system according to claim 4, wherein the input device comprises one of a keyboard and a touchscreen configured and disposed to receive a driver specific passcode.

6. The driver profile control system according to claim 4, wherein the input device comprises a biometric reader.

7. The driver profile control system according to claim 6, wherein the biometric reader includes a fingerprint reader.

8. A motor vehicle comprising:
a vehicle body supporting an engine, an environmental control system, an external communication system, a comfort control system and a driver profile control system configured and disposed to enable a driver to establish a driver specific profile including driver preference settings for one or more of the engine, the environment control system, the external communication system and the comfort control system, the driver profile control system including:
a driver identification module configured to receive a driver specific identifier;
a driver profile manager module operatively connected to the driver identification module, the driver profile manager module including one or more driver profiles, one of the one or more driver profiles being associated with the driver specific identifier; and
a driver profile control module operatively connected to the driver profile manager module, the driver profile control module being configured and disposed to establish the one of the one or more driver profiles associated with the driver specific identifier.

9. The motor vehicle according to claim 8, further comprising: a driver profile programming module operatively connected to the driver profile manager module, the driver profile programming module being configured and disposed to establish the one or more driver profiles.

10. The motor vehicle according to claim 9, further comprising: an available programmable options module including a database listing available programming options for the one or more driver profiles.

11. The motor vehicle according to claim 8, further comprising: an input device operatively connected to the driver identification module, the input device being configured and disposed to receive the driver specific identifier.

12. The motor vehicle according to claim 11, wherein the input device comprises one of a keyboard and a touchscreen configured and disposed to receive a driver specific passcode.

13. The motor vehicle according to claim 11, wherein the input device comprises a biometric reader.

14. The motor vehicle according to claim 13, wherein the biometric reader includes a fingerprint reader.

15. A method of establishing a driver specific profile for a motor vehicle, the method comprising:
receiving a driver specific identifier through an input device;
associating the driver specific identifier with a driver profile; and
establishing driver specific vehicle setting preferences stored in the driver profile.

16. The method of claim 15, wherein receiving the driver specific identifier includes receiving a passcode input through an input device.

17. The method of claim 15, wherein receiving the driver specific identifier includes receiving a biometric identifier through a biometric reader.

18. The method of claim 17, wherein receiving the biometric identifier includes reading a fingerprint.

19. The method of claim 15, further comprising: programming a driver specific profile associated with the driver specific identifier.

20. The method of claim 15, further comprising: entering a valet mode if the driver specific identifier is not associated with a driver profile.
